(19) United States
(12) Patent Application Publication
(10) Pub. No.: US 2007/0061160 A1
(43) Pub. Date: Mar. 15, 2007

(54) Comprehensive system with retention capability for a survivor

(76) Inventor: Robert Fisher, Naperville, IL (US)

Correspondence Address: WALLENSTEIN & WAGNER, LTD., 311 SOUTH WACKER DRIVE, 53RD FLOOR, CHICAGO, IL, 60606, US

(21) Appl. No.: 11/226,714

(22) Filed: Sep. 14, 2005

(51) Int. Cl. G06Q 99/00

(52) U.S. Cl. 705/1

(57) ABSTRACT

A system for assembling, retaining, and using information pertaining to an individual's life and estate in preparation for the individual's death or incapacitation is provided. The system has an instruction including a first set of directions for assembling a source of information regarding a first individual's life and estate. The instruction also has a second set of directions for using the source of information by a second individual upon the death or incapacitation of the first individual. The system also includes a plurality of forms for recording and storing the source of information.

### TECHNICAL FIELD

The invention relates to a planning system for aiding a survivor upon the death of a loved one. More particularly, the invention relates to a comprehensive planning system and method for assembling and retaining information pertaining to an individual's life and estate in combination with a comprehensive system and method for using the assembled information upon a person's death or incapacitation.

### BACKGROUND OF THE INVENTION

Thinking about the death of a loved one is always difficult. It brings to mind not only the loss of a cherished family member or friend, but it also reminds a person of his/her own mortality. Sooner or later, everyone has to deal with the death of a relative or close friend. A personal contingency plan is thus warranted.

Grief caused by the death of a loved one is an emotional phenomenon. People associate it with pain and suffering, but grief is an essential part of the normal process of acknowledging the death of a loved one and starting to rebuild a life without that person. Grief is an individual process. Everyone's experience is different, depending on many factors, such as age, health, cultural and religious background, and whether survivors have other close family members.

Following the departure of a loved one, depression, loneliness and a sense of isolation may occur, especially if the survivor is responsible for taking care of the deceased's affairs. The survivor may experience loss of appetite, insomnia, headaches or other physical symptoms. The survivor may experience confusion or difficulty in concentrating, forgetfulness and the inability to make decisions once the reality of the death begins to take hold. Depression is a normal, healthy byproduct of grief and one of the first signs that the healing process has begun.

In any event, after the death, the survivor will have to handle many details. Death brings with it many legal and financial concerns that survivors must address. For example, the grieving survivor must recover, locate and claim survivor benefits and handle the duties and responsibilities of an executor. There are also many things to consider when making final arrangements, including organizing affairs, developing and managing an estate plan, and making funeral arrangements.

The present invention is provided to help survivors cope with the loss of a loved one by providing a system and method for organizing and retaining personal life and estate information and other valuable information. A full discussion of the features and advantages of the present invention is deferred to the following detailed description, which proceeds with reference to the accompanying drawings.

### SUMMARY OF THE INVENTION

One object of the present invention is to provide a method for assembling, retaining, and using pertinent information regarding an individual's life and estate. The method comprises the steps of providing a plurality of forms on which a series of information regarding a first individual's life and estate can be recorded, providing a first set of instructions for completing the plurality of forms, providing a second set of instructions for using the plurality of forms by a second individual upon the death or incapacitation of the first individual, and providing a means for fastening the plurality of forms together.

Another object of the present invention is to provide a method for assembling, retaining, and using pertinent information regarding an individual's life and estate. The method comprises the steps of compiling information regarding the life and estate of a first individual, providing a pre-selected group of forms, providing an assembler's flowchart including stepwise instructions for completing the pre-selected group of forms, recording the compiled information on the pre-selected group of forms; providing means for identifying each of the pre-selected group of forms, binding the pre-selected group of forms together to create a source of information regarding the life and estate of the first individual, and providing a survivor's flowchart including stepwise instructions for coping with the death or incapacitation of the first individual. The survivor's flowchart includes a time reference identifying a time frame by which the stepwise instructions for coping with the death or incapacitation of the first individual should be commenced.

Another object of the present invention is to provide a system for assembling, retaining, and using information pertaining to an individual's life and estate in preparation for the individual's death or incapacitation. The system comprises an instruction including a first set of directions for assembling a source of information regarding a first individual's life and estate and a second set of directions for using the source of information by a second individual upon the death of the first individual, and a plurality of forms for recording and storing the source of information.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is an illustration of a system of the present invention;

FIG. 2 is an illustration of an alternative embodiment of the system of the present invention;

FIG. 3 is a flowchart for assembling a source of information;

FIG. 4 is an alternative flowchart for assembling a source of information;

FIG. 5 to FIG. 19 are forms, screen shots, or web pages for entry of personal information regarding an individual's life and estate;

FIG. 20 to FIG. 23 are form letters, screen shots, or web pages used as templates for notifying third parties of an individual's death or incapacitation;

FIG. 24A and FIG. 24B illustrate a survivor's flowchart showing a stepwise process of instructions for coping with an individual's death or incapacitation;

FIG. 25 are forms, screen shots, or web pages for use by a survivor in conjunction with the survivor's flowchart;

FIG. 26 is an illustration of a form, screen shot, or web page for logging events subsequent to a persons death or incapacitation; and

FIG. 27 is a form for providing guidance for developing a new life.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention is directed to a system including stepwise instructions for compiling personal information and assembling the personal information into a comprehensive source of the information and personal contingency plan. The present invention further includes stepwise instructions for using the comprehensive source upon a person's death.

The invention is designed to ease a survivor's stress during an extremely difficult and emotional time, and it also ensures that the decedent's wishes are carried out after she or he dies or becomes incapacitated. The invention disclosed herein has been designed to help gather and document vital information regarding things such as record organization, estate planning, and funeral and burial arrangements, all of which survivors will need upon the death of a loved one.

The present invention provides the following: (1) a logical organization and restoration mechanism for a broad range of personal affairs; (2) an easy to follow flowchart to assist an assembler in the construction of the personalized guide; (3) an easy to follow flowchart to assist the survivor in navigating the stressful, confusing, and often frustrating path to be followed subsequent to the loss of a loved one; (4) a comprehensive collection of important personal information; (5) direction to other important resources and contacts; (6) forms to ease the administrative burden so often linked to this period; (7) high assurance that personal plans and wishes are executed.

Benefits of the present invention include: (1) the peace of mind provided the assembler knowing that his or her affairs are in order and that survivors are taken care of to the best of one's ability; (2) the comfort provided a personal survivor knowing that a contingency plan exists in the event of the inevitable; (3) the enhanced ability to execute the wishes and affairs of the deceased with minimal frustration, financial loss and opportunity.

The present invention includes a system for assembling, retaining, and using information pertaining to an individual's life and estate in preparation for the individual's death or incapacitation. The system includes instructions including a first set of directions for assembling a source of information regarding a first individual's life and estate and a second set of directions for using the source of information by a second individual upon the death of the first individual. The system also includes a plurality of forms for recording and storing the life and estate information. The system may further include a means for binding the completed forms together once the forms have been completed by the first individual. Finally, the system may also include a plurality of dividers for separating the forms once the forms are fastened together by the means for binding.

The means for binding can be any fastening device suitable for holding multiple papers together, including but not limited to binder clips, paper clips, other clips, binder rings, pocketed folders, etc. The preferred means for binding is a two or three ring binder in which papers can be readily bound or removed.

The instruction includes an assembler's flowchart and a survivor's flowchart, both including stepwise directions. The assembler's flowchart includes a plurality of assembler's steps for creating the source of information. The survivor's flowchart includes a plurality of survivor's steps for using the source of information as well as other steps for coping or dealing with the death or incapacitation of the first individual. The survivor's flowchart further includes a time reference for instructing the survivor to perform each survivor step within a predetermined timeframe. The survivor's steps may include and refer to a plurality of survivor's forms which may selectively include a note written by the first individual. The note could include special instructions for a given step or the like.

The instruction may also include and refer to a plurality of form letters. The form letters can be used to notify various individuals, companies, agencies, and the like that the first individual has died or has become incapacitated.

The plurality of forms includes at least one assembler's personal contact form for recording names and addresses of people known to the first individual and at least one assembler's personal property form for recording the identification of personal property owned by the first individual.

The present invention also includes a method for assembling, retaining, and using pertinent information regarding an individual's life and estate. The method comprises the steps of providing a plurality of forms on which a series of information regarding a first individual's life and estate can be recorded; providing a first set of instructions for completing the plurality of forms; providing a second set of instructions for using the plurality of forms by a second individual upon the death of the first individual; and providing a means for fastening or binding the plurality of forms together.

The method may further comprise the step of completing the plurality of forms with written information regarding the first individual's life and estate; fastening the plurality of forms together using the means for fastening; providing a plurality of dividers; and fastening the dividers between each of the plurality of forms.

The present invention includes another method for assembling, retaining, and using pertinent information regarding an individual's life and estate. This method comprises the steps of compiling information regarding the life and estate of a first individual; providing a pre-selected group of forms; providing an assembler's flowchart including stepwise instructions for completing the pre-selected group of forms; recording the compiled information on the pre-selected group of forms; providing means for identifying each of the pre-selected group of forms such as tabs, dividers, stickers, and the like; binding the pre-selected group of forms together to create a source of information regarding the life and estate of the first individual; and providing a survivor's flowchart including stepwise instructions for coping with the death or incapacitation of the first individual. The survivor's flowchart includes a time reference identifying a timeframe by which each stepwise instruction for coping with the death or incapacitation of the first individual should be commenced and/or completed.

The system may also include specialized greeting cards designed for notes to loved ones, military supplements for specific military benefits, firemen, teachers, etc. The means for retaining may include retention pouches to retain business cards, etc., customized binder content for photos, etc.

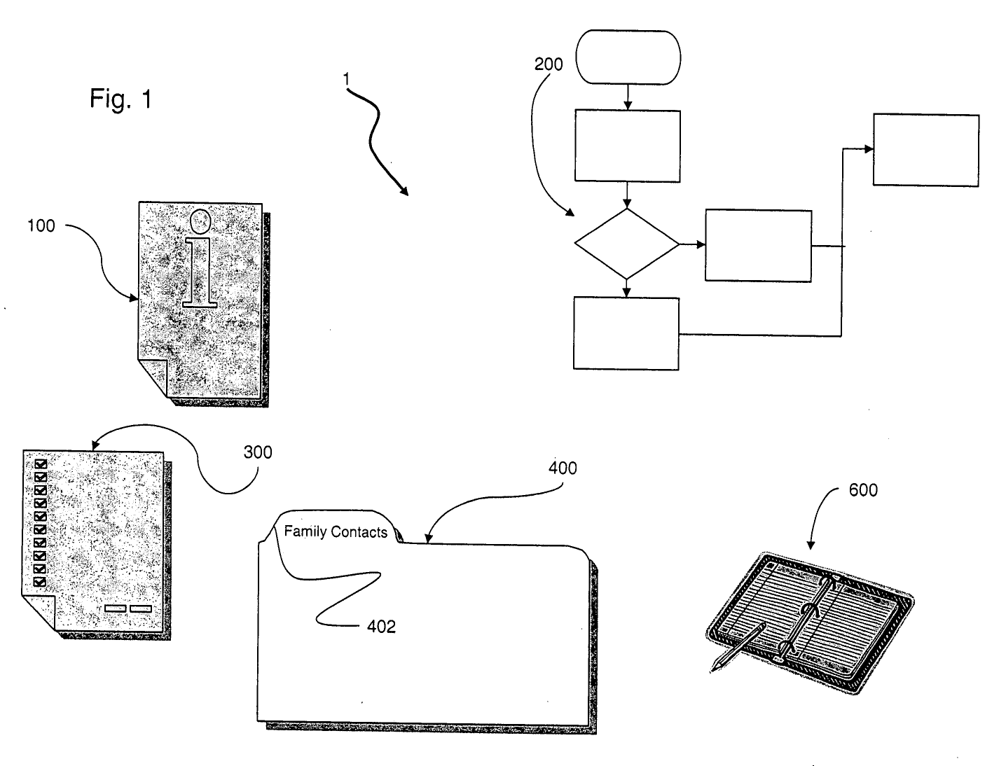

In the figures, arrows indicate the direction of data flow and/or the general order in which tasks are to be accomplished. Now referring to the figures, FIG. 1 shows a system 1 of the present invention including instructions 100, charts 200, medium forms 300, a medium for storing information such as a binder/file folder or the like 400 for securing personal information in a sectional format, alternatively or in addition a notebook 600.

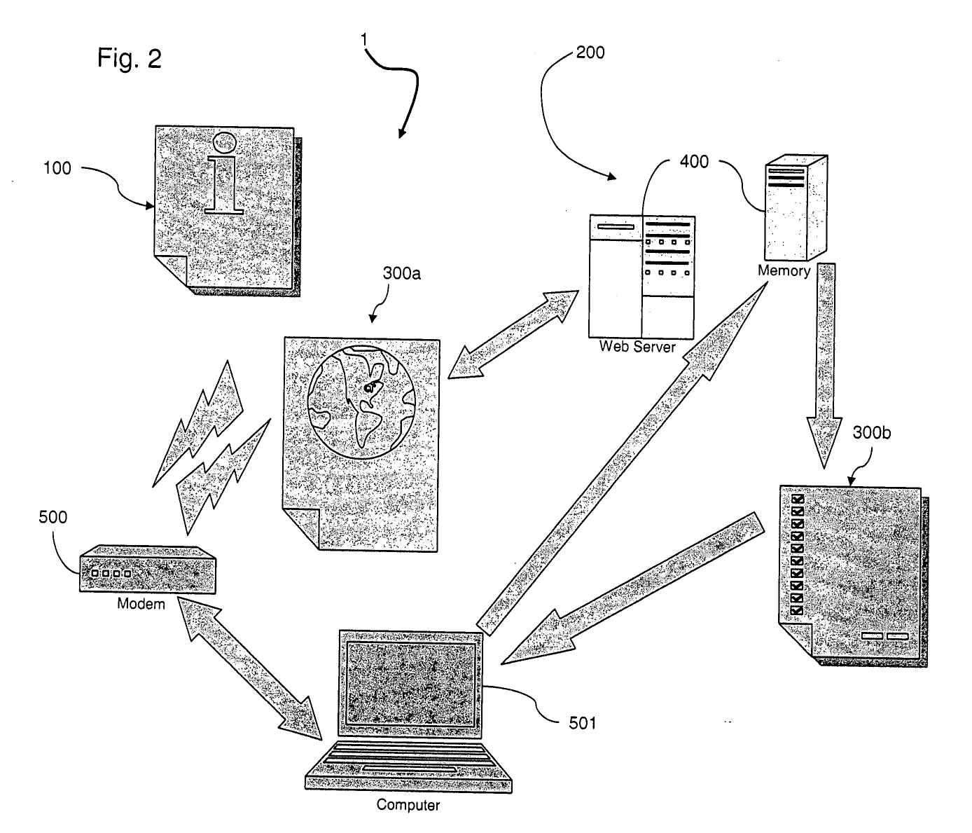

The present invention can be embodied in a paper format, in virtual format, web-based format, software format, and/or in a computer network environment, etc. Referring to FIG. 2, the system 1 of the present invention can be supplied as a software program and package. It follows that the methods and charts described herein can be embodied in computer code, the forms can be formatted computer screens or pages, and the means for binding or fastening can include any computer code for storing the forms on any RAM or ROM format. Any or all of the method steps can be performed on the internet or by computer software.

In a web-based format, the system may include blogging, chat, and/or message board capabilities. A product sales outlet for goods, e.g. books, financial and legal forms, spare binders, etc., and services, e.g. specialized financial tools, burial insurance, special savings accounts, grief and financial support and network, and dating services.

For example, the charts 200 can be stored as software code in a memory device and/or web server. The web server can transmit forms 300 in the form of web pages 300a which are transferred via a modem 500 to a remote computer 501. The source of information can be bound (i.e. saved) in the computer's memory or sent via modem back to the web server where it can be stored.

Alternatively, the charts 200 are stored as software in a memory device. The software can generate forms 300b which are transmitted to the computer screen. Information can be entered on the forms via the computer 501. The source of information can be saved to the memory device or uploaded via the internet to a web server.

Creating and Assembling a Source of Information

The basic method of creating and assembling a source of information comprises the following steps: 1) selecting applicable section tabs; 2) using blank sub-tab dividers and labels provided to create applicable sub-tab dividers; 3) inserting or binding selected tab and sub-tab dividers; 3) selecting and preparing data sheets available; 4) completing forms with pertinent personal data; 4) inserting data sheets into applicable tabbed sections; 5) selecting and inserting applicable cards into card holder provided; 6) for each selected sub-tab, identifying necessary documentation; 7) collecting applicable paperwork; 8) inserting applicable paperwork into tabbed sections; 9) collecting and/or identifying supporting administrative records; 10) reviewing retention requirement for each document; 11) eliminating unnecessary documentation; 12) organizing and filing supporting documentation; 13) identifying the location of key supporting documentation; 14) identifying and reviewing gaps in essential administration; 15) identifying contingency funding, funding for funeral expenses, and funding for 3 months post funeral; 16) writing and retaining notes to survivors; 17) conducting briefings with legal advisor, loved ones and executor; and 18) storing the guide in a secure fireproof place.

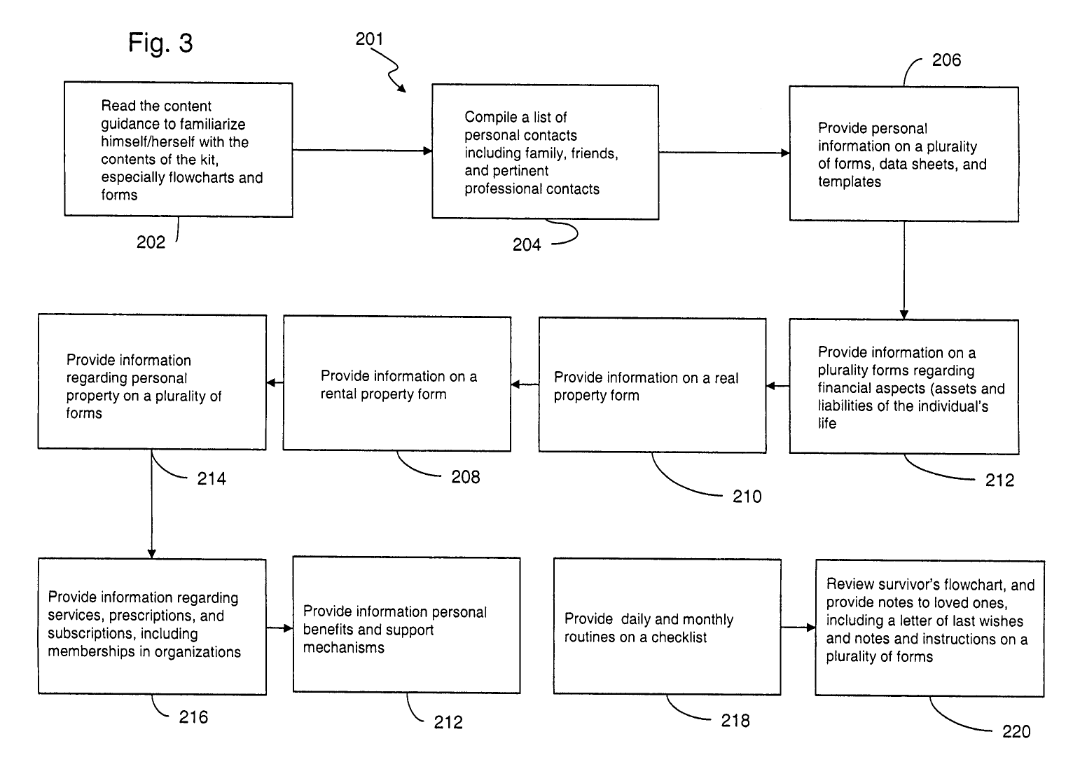

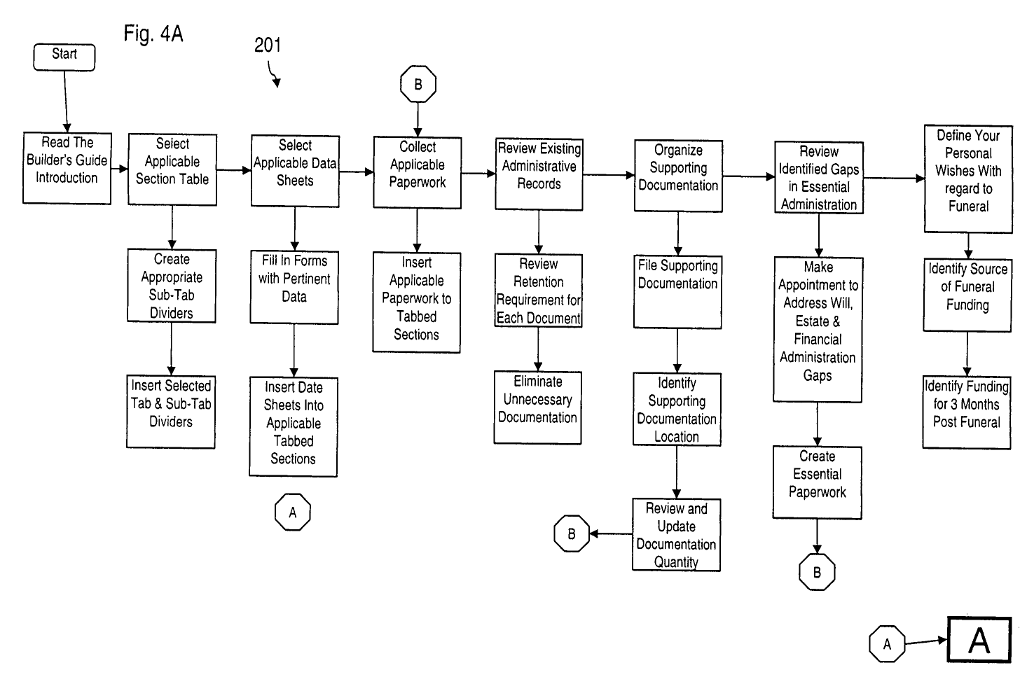

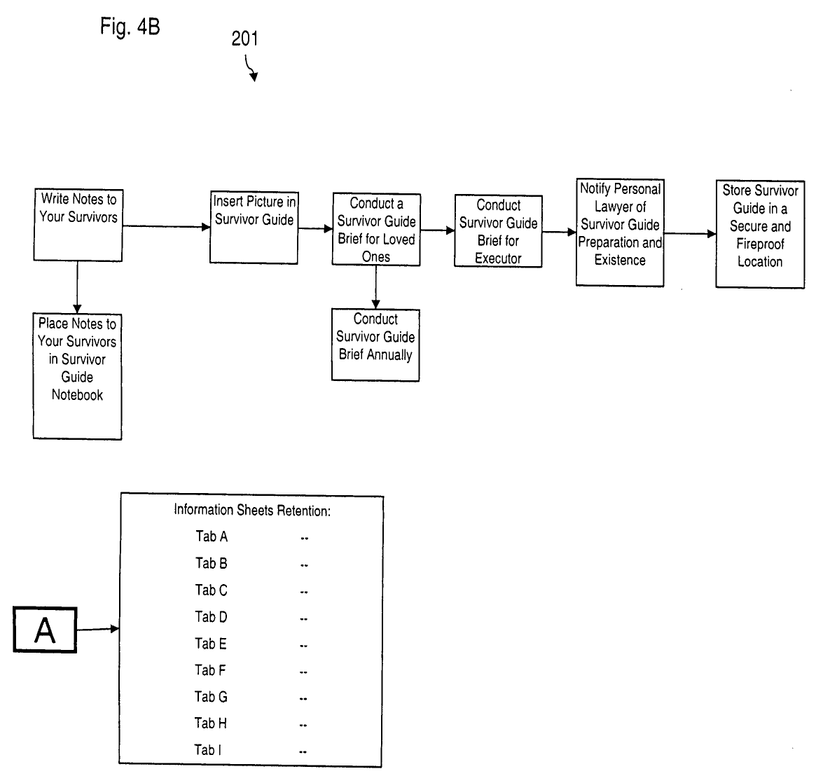

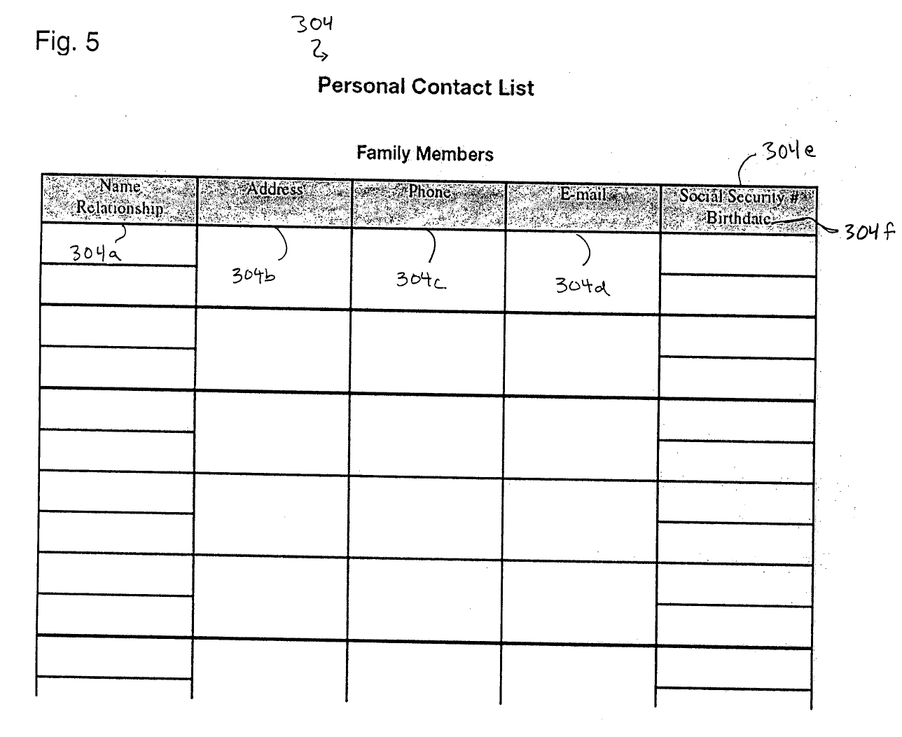

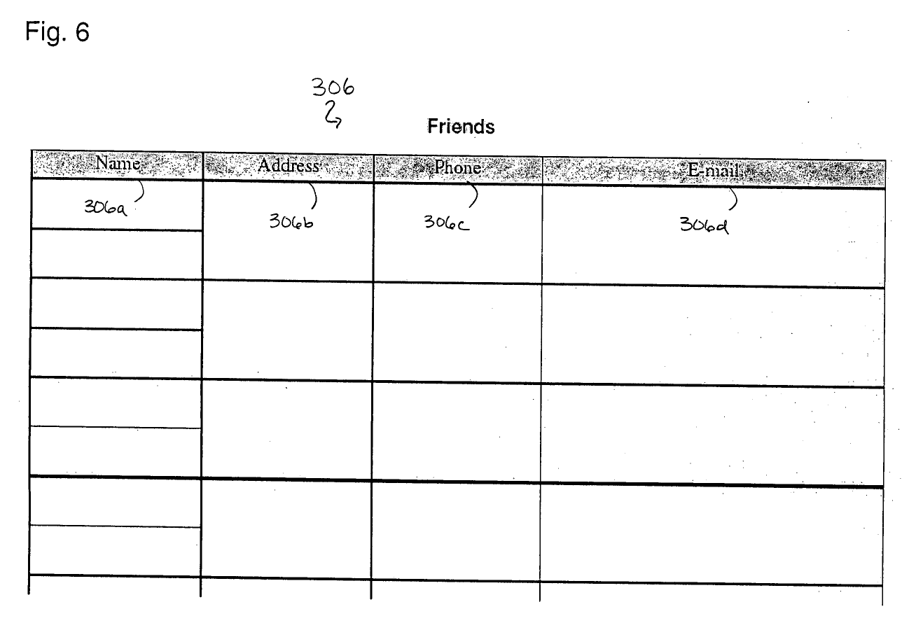

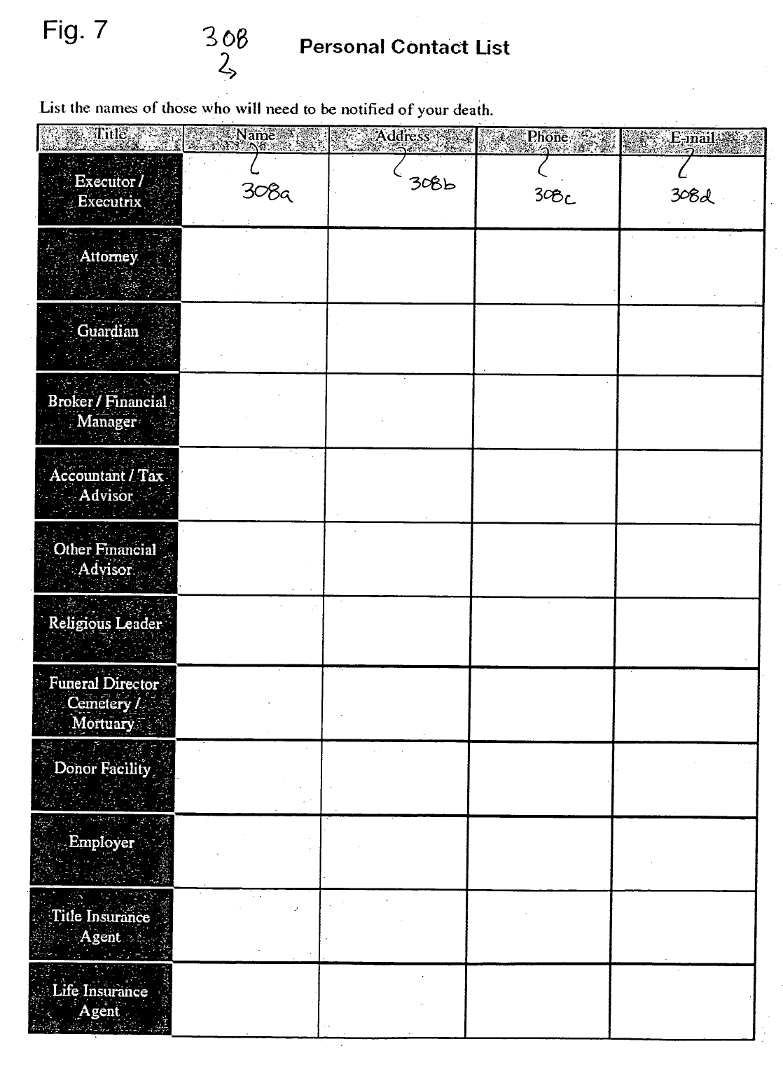

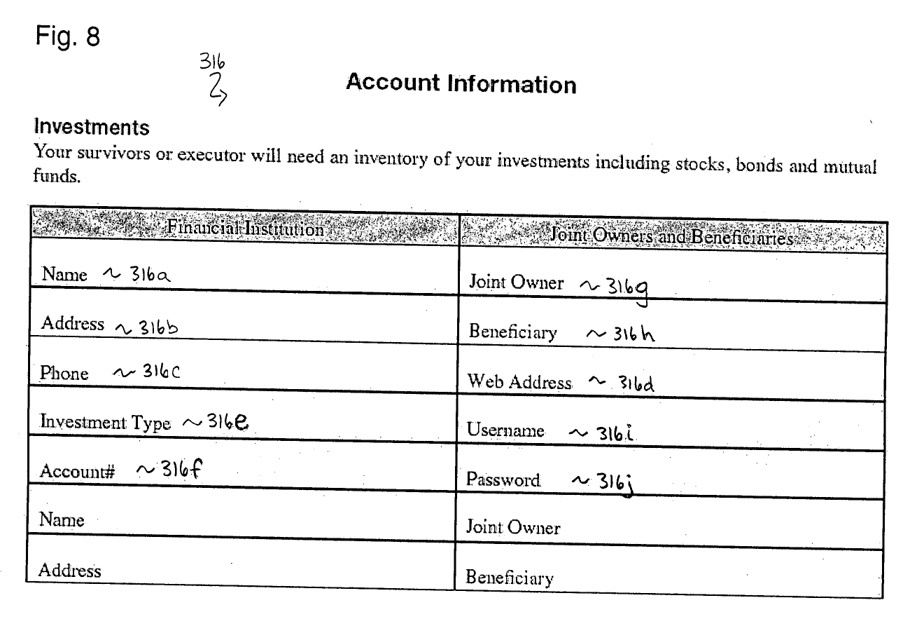

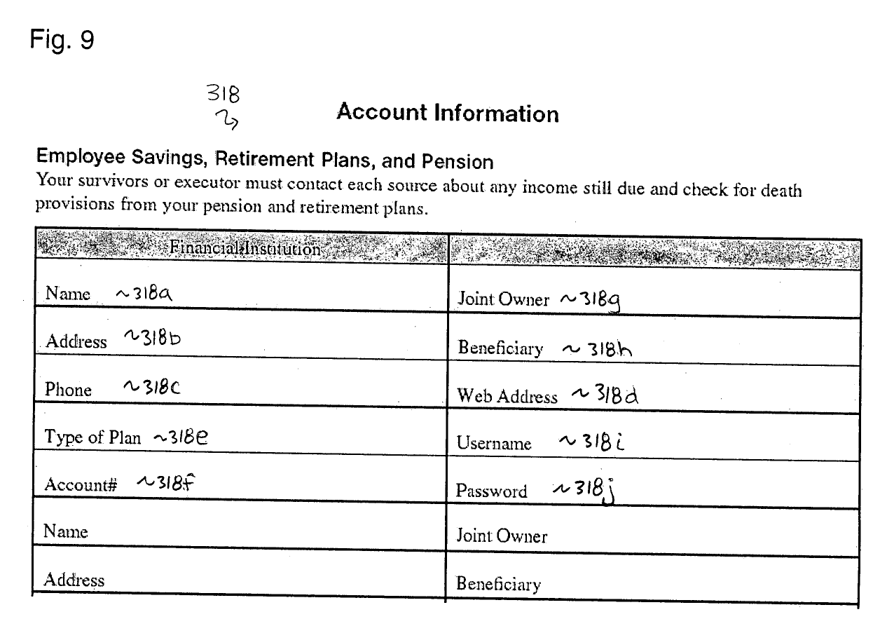

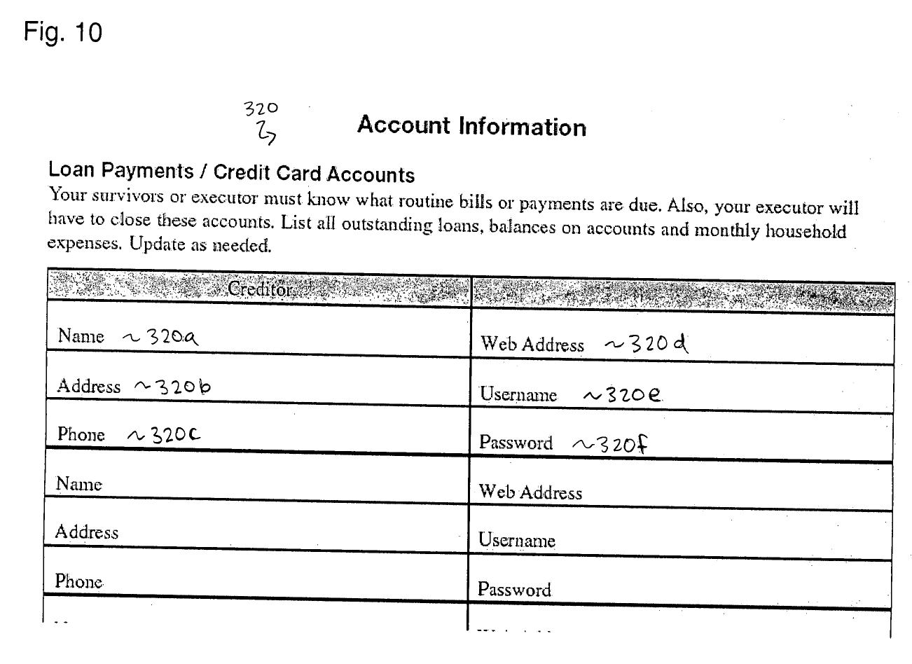

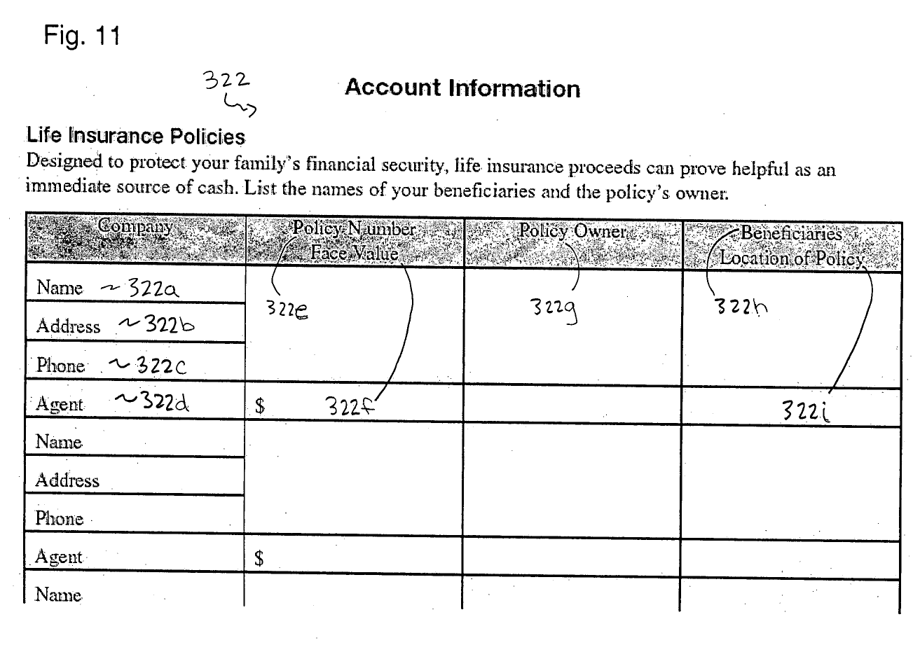

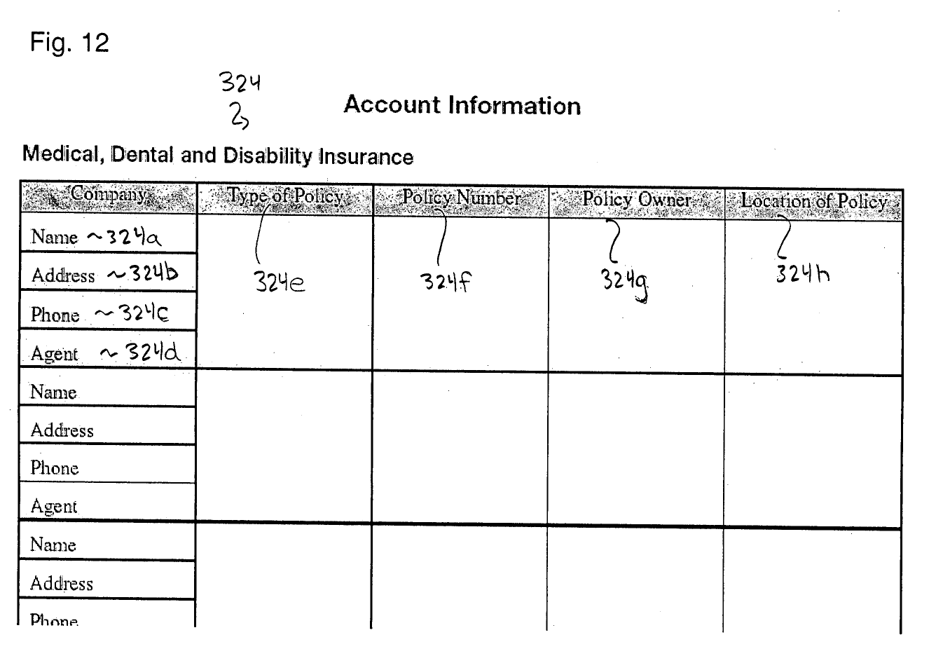

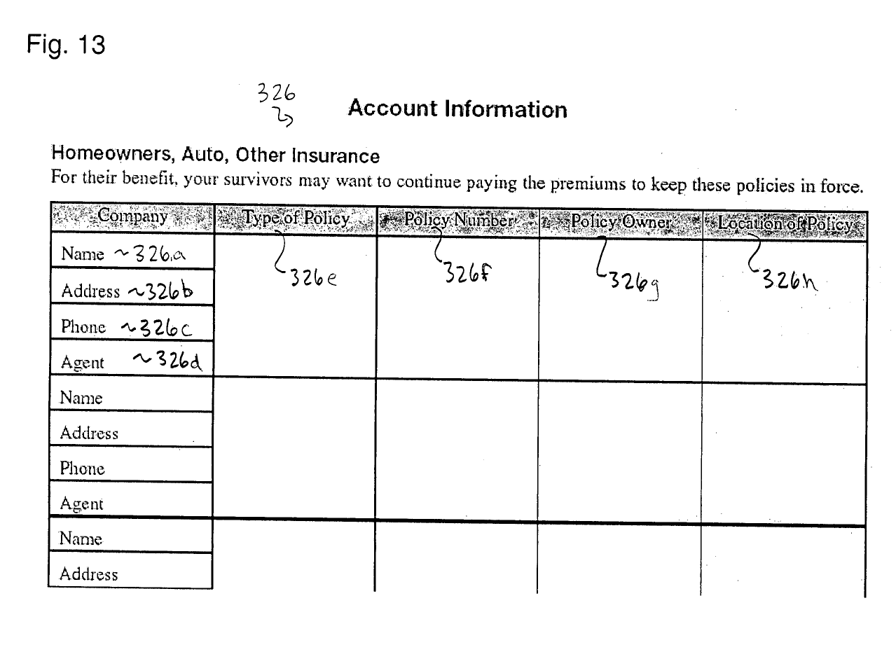

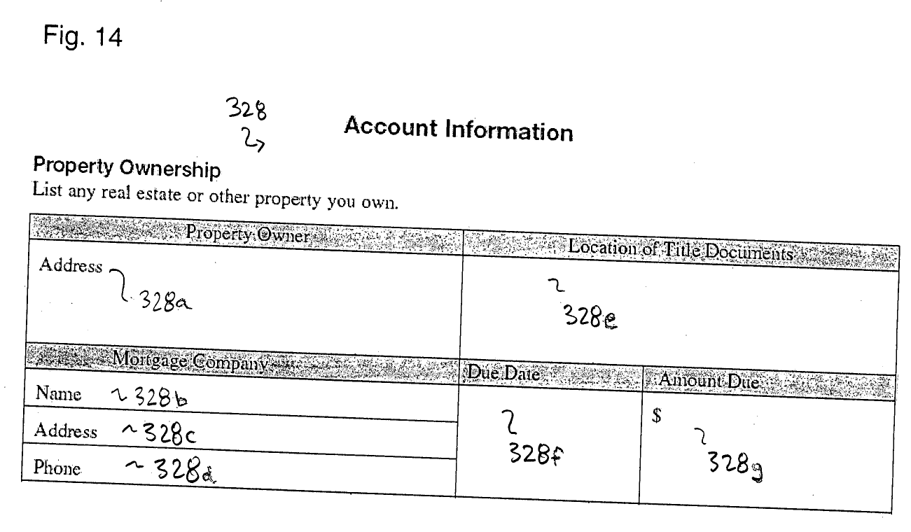

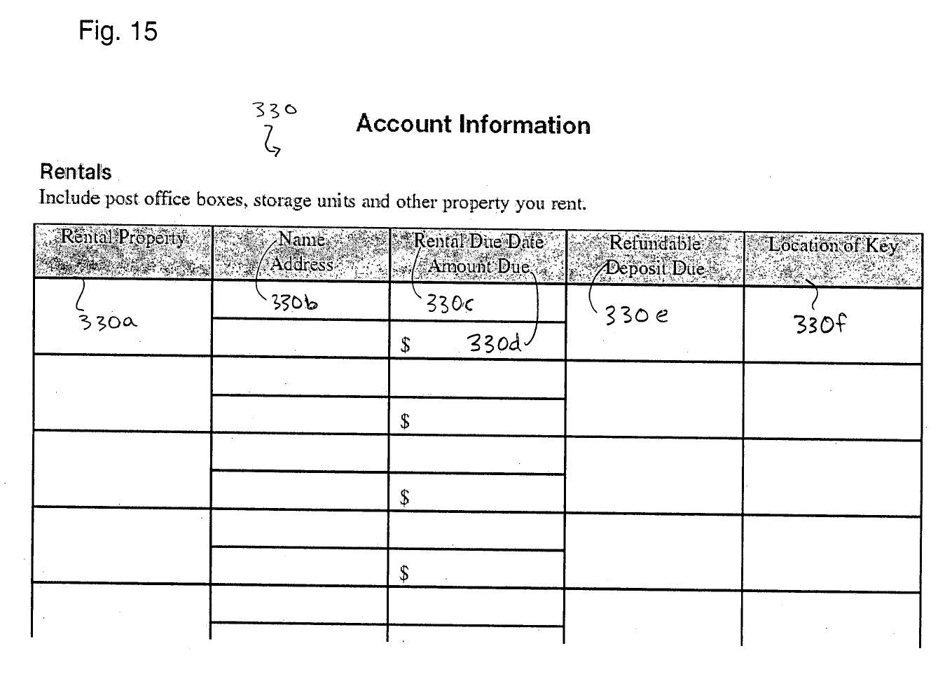

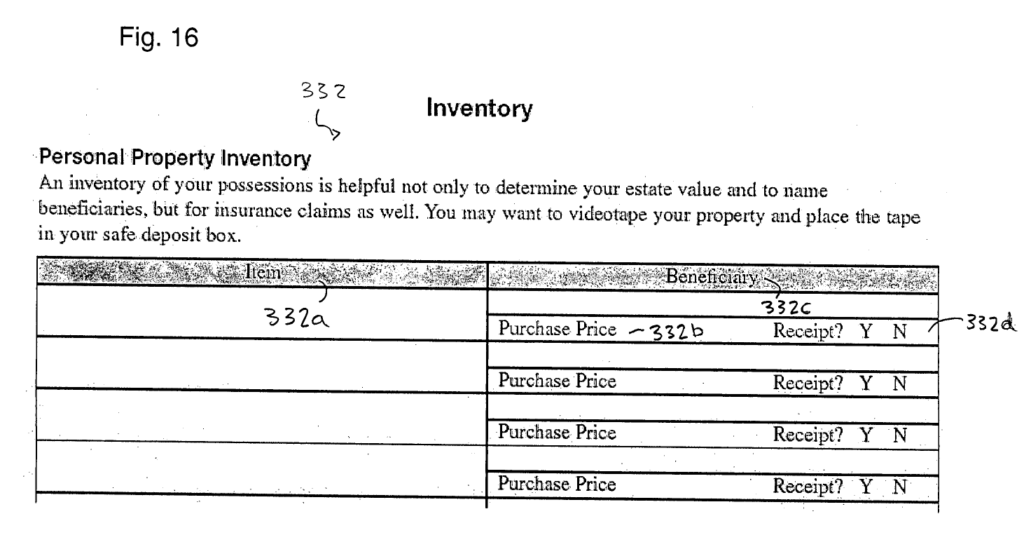

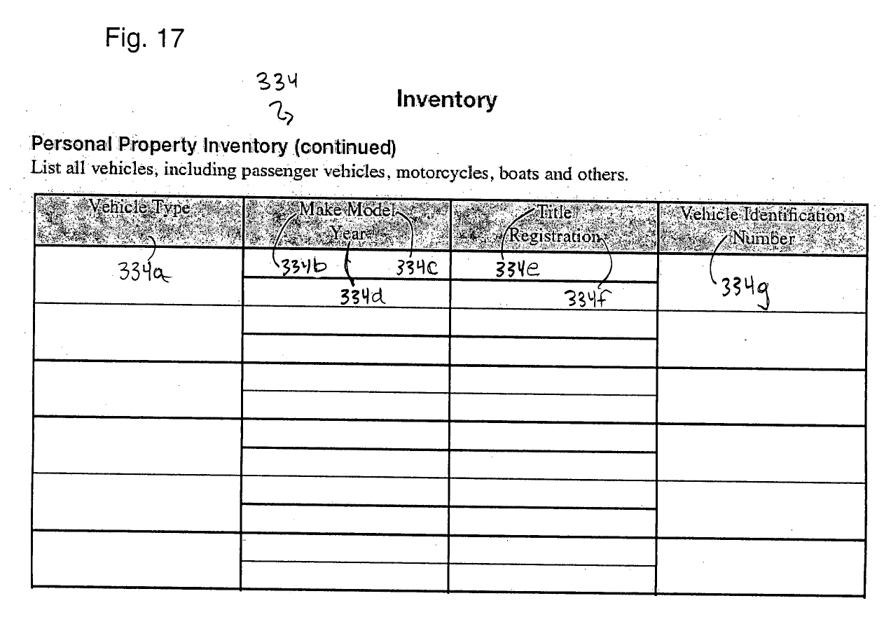

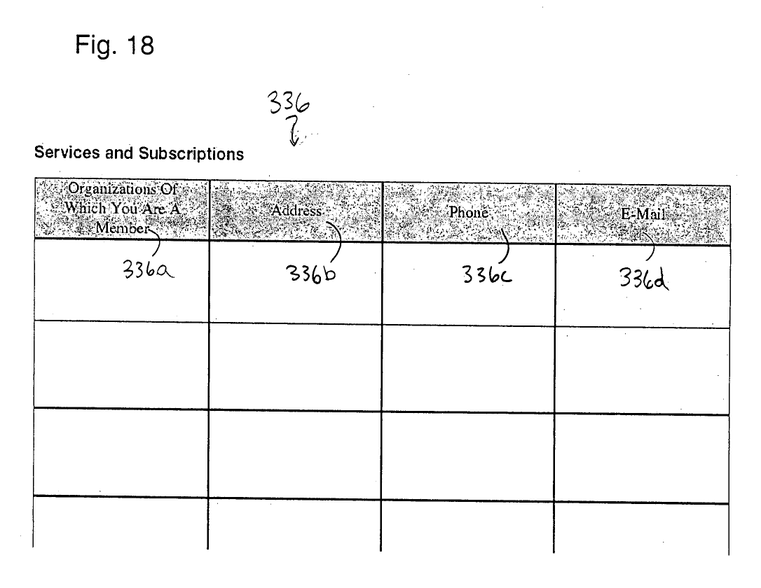

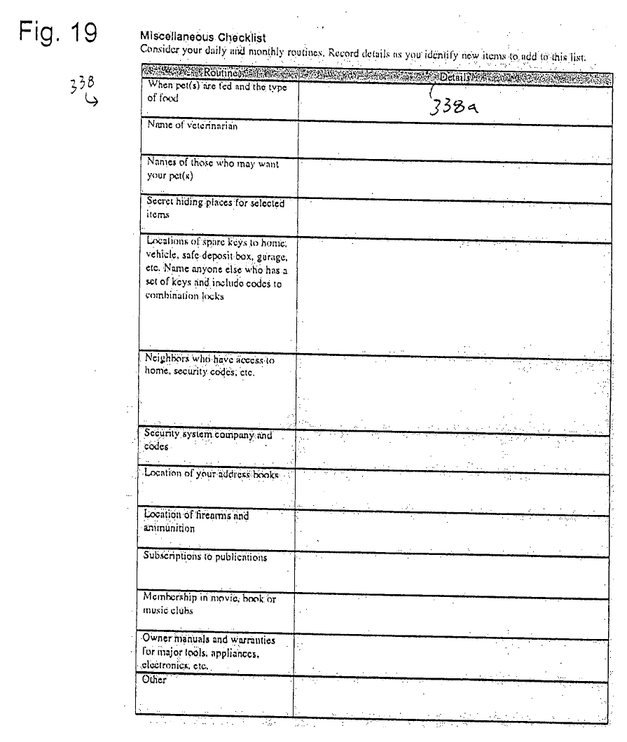

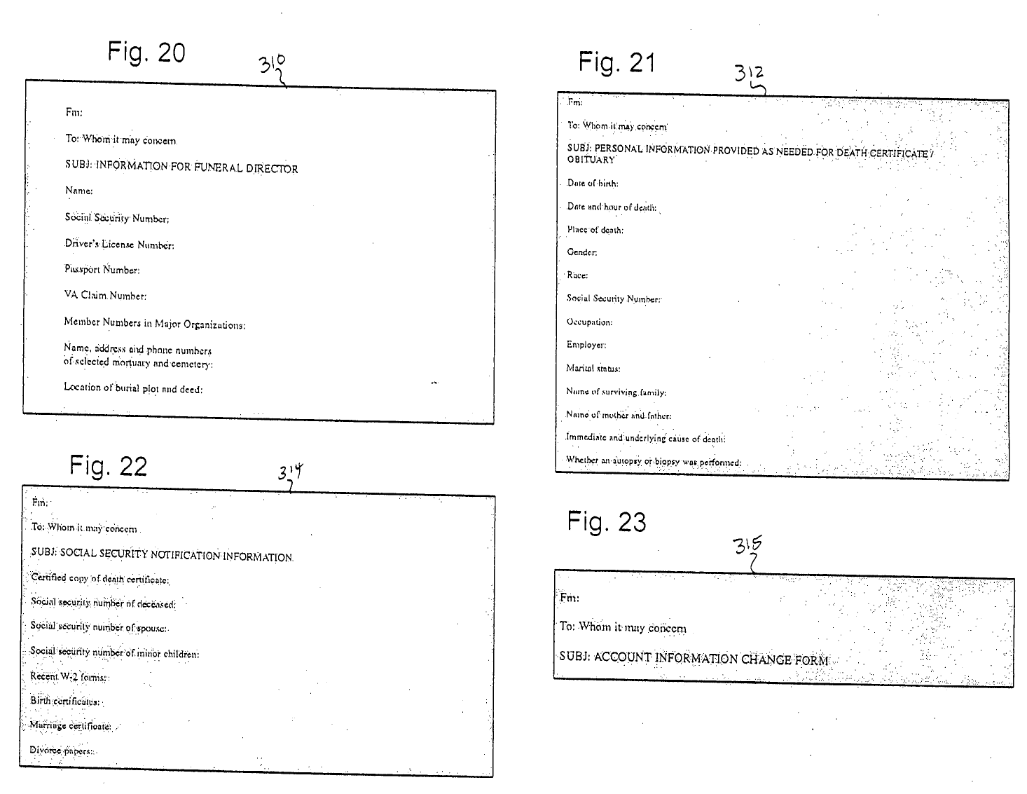

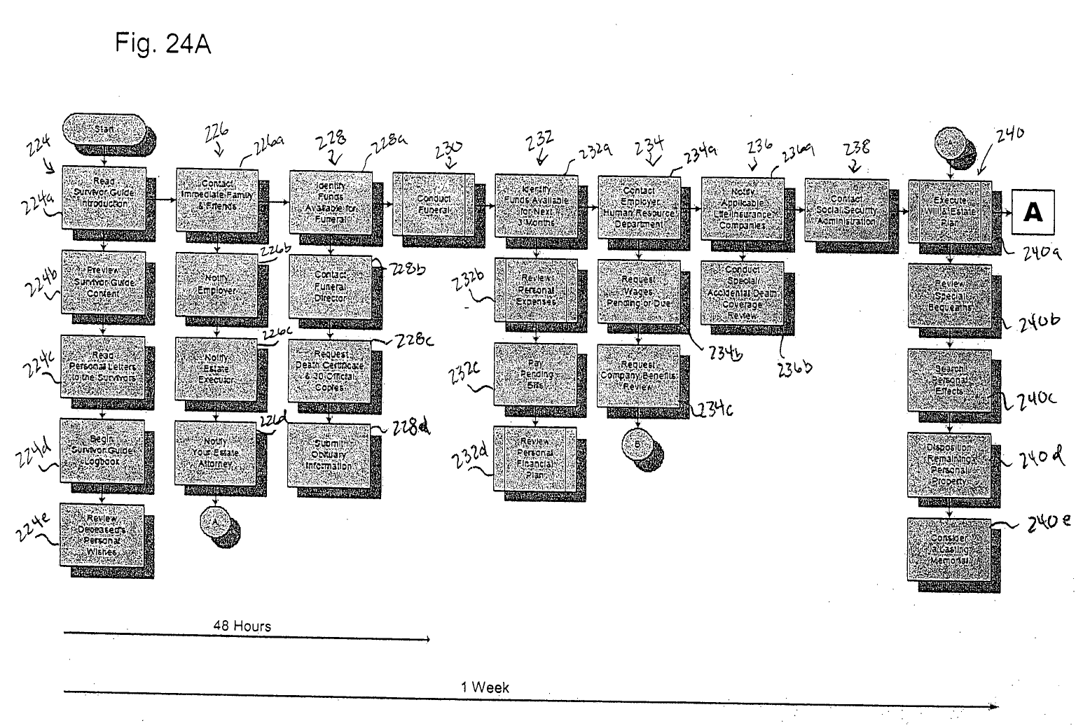

Referring to FIGS. 1-25, the instructions include a flowchart 201 for compiling personal information and assembling a source of information about the life and estate of an individual, including several forms 300 and form letters.

In a first step 202, a person assembling the information, preferably the individual about whom the information pertains, is instructed to read through the complete contents of the system 1 to familiarize himself/herself with its contents, especially the charts 200 and the forms 300.

A second step 204 is to compile a list of personal contacts including family and friends. The second step 204 requires entering contact information on a plurality of provided forms. Contact information is provided for friends and professionals who will most likely be contacted during the coming year. Once completed, the forms are fastened within the binder 400 behind an appropriate tab 402.

The pre-printed tabs 402 may be selected from the following groups: 1) personal information 2) physical property; 3) estate plan; 4) benefits; 5) financial assets; 6) professional services; 7) financial liabilities each group tab 402 can have several sub-group tabs 402.

For instance, personal information may include tabs for: birth certificates, personal contacts, professional contacts, accounts (usernames and passwords), financial plan, employment, bills and budgets, banking accounts, dd214, memoirs, and family tree.

The estate plan may include tabs for: will, funeral arrangements and wishes, special bequeaths, healthcare directives, power of attorney documents, trusts, foundations, divorce decree etc.

The financial assets may include tabs for: investment accounts, company stock plans, company stock options, annuities, educational savings accounts, dependent accounts, business entities, pension plans, social security, IRA, 401k, Keough, and tax deferred accounts, etc.

The financial liabilities may include tabs for: credit cards, auto loans, personal loans, mortgages, other obligations, and income taxes, etc.

The physical property may include tabs for: property data, deeds, titles, mortgages, leases, home owner insurance, property management information, automobiles, recreational vehicles, coins, commodities, antiques, memorabilia, and safety deposit box, etc.

The benefits may include tabs for: employer data, umbrella insurance, life insurance, auto insurance, personal property insurance, liability insurance, mortgage insurance, short term disability insurance, long term disability insurance, medical insurance, dental insurance, vision care, long term care, healthcare savings accounts, and severance plans, etc.

The professional services may include tabs for: child services, domestic services, pet services, club memberships, subscriptions and information services, and miscellaneous, etc.

The means for retaining the information may include clips, card holders, key holders, retention pouches, and tab pockets, etc.

A first form or family contact form 304 is provided for entering relevant information such as names and relationship 304a, addresses 304b, telephone numbers 304c, email addresses 304d, social security numbers 304e, and dates of birth 304f of the individual's family. Once this family contact form 304 is completed, the form 304 is fastened within the binder 400 behind a tab 402, optionally marked with an appropriate identifier.

A second form or friends contact form 306 is also provided. This form includes blanks for identifying the names 306a, addresses 306b, telephone numbers 306c, and email addresses 306d for the assembler's/decedent's friends. Once this friends contact form 306 is completed, the form 306 is fastened within the binder 400 behind an identifying tab 402.

A third form or special contacts form 308 is also provided. This form includes blanks for identifying special contacts and their respective names 308a, addresses 308b, telephone numbers 308c, and email addresses 308c. These special contacts include executor/executrix, attorney(s), guardian, broker/financial manager, accountant/tax advisor, other financial advisors, religious leader(s), funeral director, cemetery, mortuary, donor facility, employer, title insurance agent, and life insurance agent. Other special contacts can be included when identified and needed. Once the information is entered on the special contacts form 308, the form 308 is fastened within the binder 400 behind an identifying tab 402.

A third step 206 requires providing information on a plurality of form letters. The form letters help to streamline important tasks that a survivor must complete upon a loved one's death, especially notifying various third parties of the death or incapacitation of the individual. Once completed, the form letters are fastened within the binder behind an appropriate tab. The term “form letters” is intended to include not only actual letters but also to broadly include instructions for preparing letters to specific third parties.

A first form letter 310 is directed to information for a funeral director. This funeral director form letter 310 includes information specific to the individual, such as social security number, driver's license number, passport number, VA claim number, personal information of interest, name, address and telephone number of selected mortuary and cemetery, and location of burial plot and deed therefore. Once the funeral director form letter 310 is completed, the form letter 310 is fastened within the binder 400 behind an appropriately labeled tab 402.

A second form letter 312 is directed to personal information for a death certificate and an obituary. Accordingly, this form letter 312 includes personal information of the individual/decedent. The personal information includes name, date of birth, date of death, time of death, place of death, gender, race, social security number, occupation, employer, marital status, names of survivors, names of mother and father, immediate and underlying cause of death, and whether an autopsy or biopsy was performed.

A third form letter 314 is directed to social security notification information. The social security form letter 314 has pertinent information needed to notify the federal government after a person dies, including a certified copy of the death certificate, social security number of the deceased, social security numbers of the spouse and children, recent W-2 forms, birth certificate, marriage certificate, and divorce papers. Once the third form letter 314 is completed with information available at the time of assembly, the form letter 314 is fastened within the binder 400 behind an appropriately labeled tab 402.

A fourth form letter 315 is directed to holders of accounts of the individual. The accounts form letter 315 is needed to remove the assembler's/decedent's name from accounts upon his/her death. Once the fourth form letter 315 is completed with information available at the time of assembly, the form letter 315 is fastened within the binder 400 behind an appropriately labeled tab 402.

A fourth step 208 requires providing information on a plurality of forms regarding the financial aspects of the individual's life and estate. The financial forms require information pertaining to accounts, investments, and the like. Once these financial forms are completed, the forms are fastened within the binder 400 under an appropriately labeled tab 402.

A first financial form 316 is directed to an inventory of financial product investments, such as stocks, bonds, mutual funds, certificates of deposit, and money market accounts. This financial product form 316 includes spaces for the name of the financial institution 316a, and other important information including address 316b, telephone number 316c, web address 316d, the investment type 316e, account number 316f, joint owner 316g, beneficiary 316h, username 316i, and password 316j. Once the first financial product form 316 is completed, the form 316 is fastened within the binder 400 behind an appropriately labeled tab 402.

A second financial form 318 is directed to an inventory of retirement investments, such as employee savings accounts, retirement plans, and pensions. This retirement investment form 318 includes spaces for the name of the financial institution 318a, and other important information including address 318b, telephone number 318c, web address 318d, the investment type 318e, account number 318f, joint owner 318g, beneficiary 318h, username 318i, and password 318j. Once the second financial form 318 is completed, the form 318 is fastened within the binder 400 behind an appropriately labeled tab 402.

A third financial form 320 is directed to an inventory of credit accounts, such as outstanding loans, credit accounts, and any household expenses. This credit account form 320 includes spaces for the name of the creditor 320a, and other important information including address 320b, telephone number 320c, web address 320d, username 320e, and password 320f. Once the third financial form 320 is completed, the form 320 is fastened within the binder 400 behind an appropriately labeled tab 402.

A fourth financial form 322 is directed to an inventory of life insurance policies. This life insurance policy form 322 includes spaces for the name of the life insurance company 322a, and other important information including address 322b, telephone number 322c, agent name 322d, account/policy number 322e, policy face value 322f, policy owner 322g, beneficiaries 322h and location of policy 322i. Once the fourth financial form 322 is completed, the form 322 is fastened within the binder 400 behind an appropriately labeled tab 402.

A fifth financial form 324 is directed to an inventory of health insurance policies, such as medical, dental, and disability insurance. This health insurance policy form 324 includes spaces for the name of the insurance company 324a, and other important information including address 324b, telephone number 324c, agent name 324d, the type of policy 324e, account/policy number 324f, policy owner 324g, and location of policy 324h. Once the fifth financial form 324 is completed, the form 324 is fastened within the binder 400 behind an appropriately labeled tab 402.

A sixth financial form 326 is directed to an inventory of other insurance policies, such as homeowners, auto, and other insurance policies. This insurance policy form 326 includes spaces for the name of the insurance company 326a, and other important information including address 326b, telephone number 326c, agent name 326d, account/policy number 326e, policy owner 326f, and location of policy 326g. Once the fourth financial form 326 is completed, the form 326 is fastened within the binder 400 behind an appropriately labeled tab 402.

A fifth step 210 requires providing information on a real property form 328 which is directed to any real estate or other property. This real property form 328 includes spaces for adding the property owner's name and address 328a, the name 328b, address 328c and telephone number 328d of the mortgage company, the location of the title documents 328e, due dates for payments 328f, and the amount due 328g. Once the real property form 328 is completed, the form 328 is fastened within the binder 400 behind an appropriately labeled tab 402.

A sixth step 212 requires providing information on a rental property form 330 which is directed to any rented property, including safety deposit boxes, post office boxes, storage units, or any other rented property. This rental property form 330 includes spaces for adding the type of property 330a, owner's name and address 330b, rental due date 330c, the amount due 330d, deposit information 330e, and the location of keys 330f. Once the rental property form 330 is completed, the form 330 is fastened within the binder 400 behind an appropriately labeled tab 402.

A seventh step 214 requires providing information regarding personal property on a plurality of forms. The personal property forms require information pertaining to personal possession that go into determining estate value. Once these personal property forms are completed, the forms are fastened within the binder 400 under an appropriately labeled tab 402.

A first personal property form 332 is directed to miscellaneous property items. This miscellaneous personal property form 332 includes spaces for the identification of the item 332a, the purchase price 332b, the intended beneficiary 332c, and whether a receipt for the item exists 332d. The form 332 also instructs the assembler to make a video of the personal property items and store the video in a safety deposit box. Once the first personal property form 332 is completed, the form 332 is fastened within the binder 400 behind an appropriately labeled tab 402.

A second personal property form 334 is directed to vehicular property items. This vehicular property form 334 includes spaces for the type of vehicle 334a, including the make 334b, model 334c, and year 334d, location of the title 334e, registration 334f, and the vehicle identification number 334g. Once the second personal property form 334 is completed, the form 334 is fastened within the binder 400 behind an appropriately labeled tab 402.

An eighth step 216 requires providing information regarding services and subscriptions, including memberships in organizations. A services and subscriptions form 336 is provided for entry of information pertaining to the name and type of service or subscription 336a, the address of the organization 336b, the telephone number 336c, and the email address 336d. Once this form 336 is completed, the form 336 is fastened within the binder 400 under an appropriately labeled tab 402.

A ninth step 218 requires logging daily and monthly routines on a miscellaneous checklist 338. The daily or monthly routines may include pet care, name of veterinarian, names of people who might want to adopt the pet, secret hiding places, locations of other items, codes, locations of spare sets of keys, security system information and codes, location of address books, location of firearms and ammunition, subscriptions to publications, memberships in clubs, location of owner's manuals, etc. The assembler should log the details 338a of each item. Once this checklist 338 is completed, the checklist 338 is fastened within the binder 400 under an appropriately labeled tab 402.

A tenth step 220 requires the assembler to review a survivor's flowchart 222, and provide notes and instructions to loved ones, including a letter of last wishes and notes and instructions on a plurality of forms that will be discussed in more detail in connection with the survivor's flowchart 222.

Using the Assembled Information

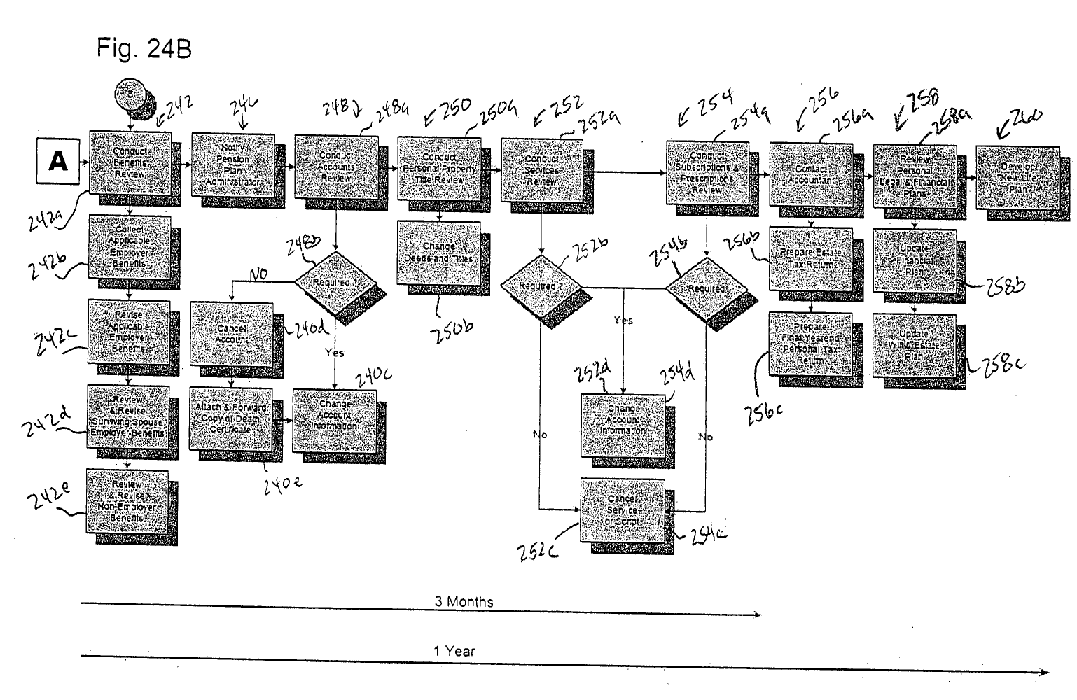

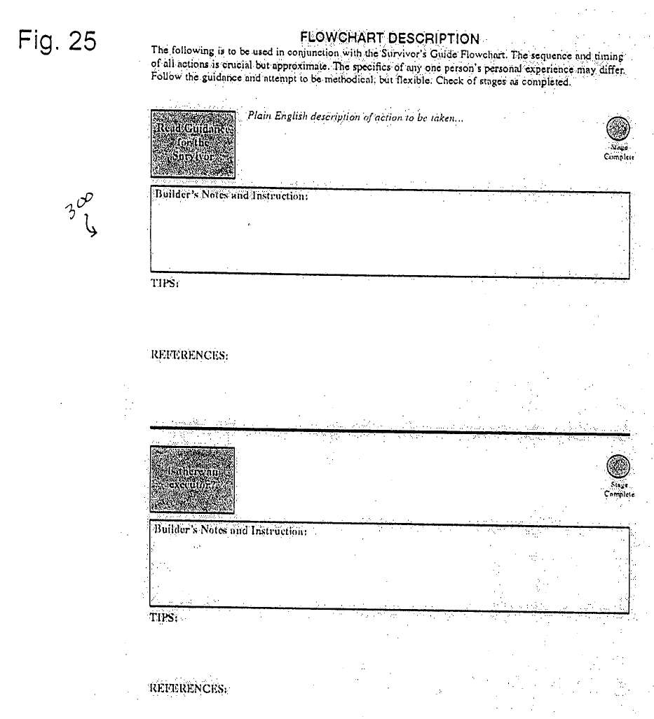

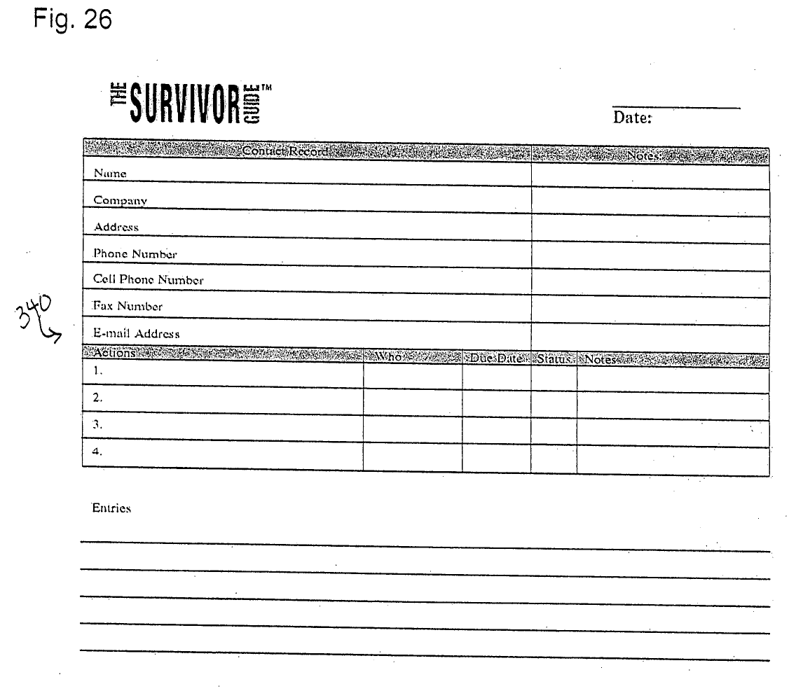

Referring to FIGS. 24-26, the instructions 100 include a survivor's flowchart 222 along with a plurality of forms 300. This survivor's flowchart 222 is intended to guide a survivor stepwise through the management of the individual's affairs in the time subsequent to the individual's death or incapacitation. The flowchart 222 is meant to be used in conjunction with the information previously supplied by the assembler and with the plurality of forms 300, which will be described in detail below, examples of which are illustrated in FIG. 25. The sequence and timing of all actions is approximate. The specifics of any one person's personal experience may differ. The flowchart 222 is meant to be followed methodically, but it is, at the same time, flexible.

Each step in the survivor's flowchart 222 is accompanied by a description of the step on a separate form. The forms may include notes from the assembler, tips, and references. The forms may also include a box to be checked upon completion of the step, see, e.g., FIG. 25.

A first survivor's step 224 requires the survivor to familiarize him/herself with the guide. The first step 224 should be performed within the first 48 hours of the decedent's death. This step includes previewing content of the guide 224a, reading personal letters 224b, beginning a logbook or logging entries and actions taken 224c on an action form 340 (see FIG. 25), and reviewing the deceased's wishes 224d.

A second survivor's step 226 requires the survivor to review personal content provided by the assembler about the deceased or incapacitated individual using the forms completed by the builder. For instance, he/she must contact immediate friends and family 226a, notify the deceased's employer 226b, notify the executor 226c, and notify the estate legal advisor and/or attorney 226d. Again, this step should be carried out within the first 48 hours of the decedent's death.

A third survivor's step 228 requires the survivor to perform tasks aimed at preparing to conduct a memorial in honor of the deceased. This step 228 includes identifying funds available for the memorial 228a, contacting a funeral director 228b, requesting copies of the death certificate 228c, and submitting obituary information 228d.

The survivor should also contact the Funeral Consumers Alliance (FCA) for information on choosing a dignified, affordable funeral, and request a trusted friend to review the costs and charges presented to the survivor by the service provider.

In the case of death, the survivor must contact a funeral provider to plan the funeral. The survivor will need information about the decedent, including: social security number, driver's license number, passport number, VA claim number, member numbers in major organizations, name, address and telephone numbers of selected mortuary and cemetery, and location burial plot and deed. This information can be found on forms created by the assembler.

A fourth survivor's step 230 is to conduct the memorial.

A fifth survivor's step 232 is to identify short term funds. This step should be performed within the first 7 days of the death. The survivor should review funds available to support the decedent's dependents in the coming months as a life plan is developed. This step includes identifying funds for the next 3 months 232a, reviewing personal expenses 232b, paying pending bills 232c, and reviewing personal financial plan 232d.

The sixth step 234 should include contacting the decedent's employer 234a, if there was one. If the deceased had been employed or subject to an employees' savings plan, the survivor should contact the employer's human resource department and inform them of the passing, providing them with the coroner's information. The survivor should also request any wages pending or due 234b, and review funds available for support.

When contacting the deceased's employer, the survivor should also request a benefits review 234c.

A seventh survivor's step 236 requires notifying the applicable life insurance companies. The information regarding the life insurance policies can be found in the assembled information. During the seventh step 236, the survivor should also review special and/or accidental death coverage 236a, if applicable. The seventh step 236 should be performed within 30 days of the death.

An eighth survivor's step 238 is to contact the social security administration. This step should be performed within the first 30 days of the death. Here, the survivor contacts the social security administration for survivor benefits. Prior to contacting the social security administration, the survivor will need a certified copy of the death certificate, social security numbers for the deceased, the surviving spouse and any minor children, copies of the deceased's most recent W-2 forms or self-employment tax return, name of the decedents employer, marriage certificate, and divorce papers, if applying as a divorced spouse. Again, most of this information can be found in the assembled information.

A ninth survivor's step 240 is to execute the will and estate plan. The survivor should acquire a copy of the will. The location of the will should be listed in the assembled information. Along with this step 240, the survivor should also contact the designated legal counsel 240, execute the will and estate plan 240a, review any special bequeaths 240b, search through the deceased personal effects 240c, dispose of remaining personal property 240d, and consider a lasting memorial for the deceased 240e. This step 240 should be carried out within the first 90 days of the death.

A tenth step 242 is to identify entitled benefits. This requires performing a benefits review 242a. Once the review is completed, the survivor should attempt to collect the applicable benefits 242b, and revise applicable employer benefits 242c, review and revise surviving spouse employer benefits 242d, and review and revise non-employer benefits 242e.

An eleventh survivor's step 246 requires the survivor to notify the deceased's pension plan of the death. This step should be conducted within the first 90 days of the death.

A twelfth survivor's step 248 requires the survivor to conduct a review of accounts 248a. This step 248 is accomplished by referring to the accounts forms supplied in the assembled information. This step includes changing the billing name to the survivor's name on joint credit cards when the next statement arrives. The survivor should ask himself/herself whether the account is required 248b. If the answer is “yes,” the survivor should use one of the form letters to change the account information 248c accordingly. If the answer is “no,” the survivor should close the account 248d. In either case, a copy of the death certificate should be attached to the request 248e. This step 248 should be completed within the first 90 days.

A thirteenth survivor's step 250 requires the survivor to conduct a personal property review 250a, including real property. This step includes, inter alia, re-titling jointly-owned real estate or other property and changing vehicle titles. A listing of the property can be found in the assembled information along with the location of the title. Once the personal property has been identified, the survivor should change the title and deeds on the property 250b accordingly. This step should be initiated within the first 90 days of the death.

A fourteenth survivor's step 252 requires the survivor to review service contracts 252a, such as trash collection, utilities, etc. The survivor should ask himself/herself whether each service is still needed 252b. If the service is not needed, the survivor should cancel it 252c. If the service is still needed, the survivor should use a form letter to change the account information 252d accordingly. This step 252 should be performed within the first 90 days of the death.

A fifteenth survivor's step 254 requires the survivor to review subscriptions and prescriptions 254a. The survivor should ask himself/herself whether each prescription or subscription is needed 254b. If the subscription or prescription is not needed, the survivor should cancel it 254c. If the subscription or prescription is still needed, the survivor should use a form letter to change the account information 254d. This step 254 should be performed within the first 90 days of the death.

A sixteenth survivor's step 256 is to contact the accountant 256a. The accountant's contact information can be found in the assembled information. The accountant or tax advisor can advise the survivor on federal, state and local income tax returns, and prepare and file all necessary tax returns. The accountant should be instructed to prepare an estate tax return 256b, and to prepare a final year-end personal tax return 256c. This step should be completed within the first 90 days after the death.

A seventeenth survivor's step 258 is for the survivor to review personal, legal, and financial plans 258a. The survivor should seek advice from an attorney or certified financial planner (CFP) practitioner on updating the survivor's estate plan (will, durable power of attorney, living will, healthcare power of attorney and letter of instruction documents) and revising trusts. Much of the information and references needed to perform this task are located in the assembled information. After the review is conducted, the survivor should update the financial plan 258b and update his/her will and estate plan 258c. This step should be started within 365 days of the death.

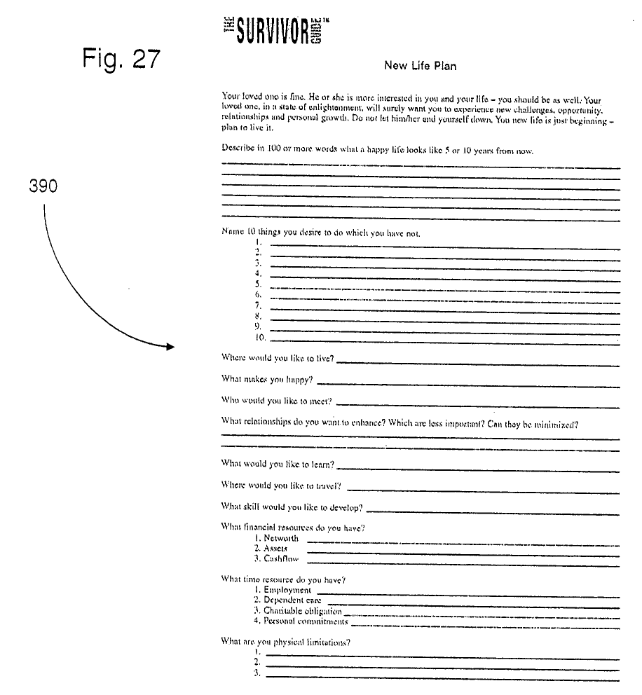

Finally, an eighteenth survivor's step 260 asks the survivor to develop a new life plan. For example, the survivor should decide where he/she wants to live. This task should be started within the first 365 days. A form 390 (FIG. 27) is provided with instructions for developing a new life plan.

While the specific embodiments have been illustrated and described, numerous modifications come to mind without significantly departing from the spirit of the invention, and the scope of protection is only limited by the scope of the accompanying claims.

What is claimed is:

1. A method for assembling, retaining, and using pertinent information regarding an individual's life and estate, the method comprising the steps of:
providing a plurality of forms on which a series of information regarding a first individual's life and estate can be recorded;
providing a first set of instructions for completing the plurality of forms; and,
providing a second set of instructions for using the plurality of forms by a second individual upon the death or incapacitation of the first individual.

2. The method of claim 1 further comprising the step of:
providing a means for fastening the plurality of forms together.

3. The method of claim 1 further comprising the step of:
completing the plurality of forms with written information regarding the first individual's life and estate.

4. The method of claim 3 further comprising the step of:
fastening the plurality of forms together using the means for fastening.

5. The method of claim 4 further comprising the steps of:
providing a plurality of dividers; and,
fastening the dividers between each of the plurality of forms.

6. The method of claim 1 wherein the first set of instructions includes an assembler's flowchart providing stepwise instructions for completing and assembling the plurality of forms.

7. The method of claim 1 wherein the second set of instructions includes a survivor's flowchart for guiding the second individual stepwise through the plurality of forms upon the death or incapacitation of the first individual.

8. The method of claim 7 wherein the survivor's flowchart includes a time reference for instructing the second individual to begin a step at a predetermined point in time.

9. The method of claim 1 wherein the second set of instructions includes a plurality of survivor's forms including notes selectively written by the first individual.

10. The method of claim 1 further comprising the step of:
providing a plurality of form letters for notifying third parties of the death or incapacitation of the first individual.

11. The method of claim 1 wherein the method is performed on a computer.

12. The method of claim 11 wherein at least a portion of the method is performed on the internet.

13. A method for assembling, retaining, and using pertinent information regarding an individual's life and estate, the method comprising the steps of:
compiling information regarding the life and estate of a first individual;
providing a pre-selected group of forms;
providing an assembler's flowchart including stepwise instructions for completing the pre-selected group of forms;
recording the compiled information on the pre-selected group of forms;
providing means for identifying each of the pre-selected group of forms;
binding the pre-selected group of forms together to create a source of information regarding the life and estate of the first individual; and,
providing a survivor's flowchart including stepwise instructions for coping with the death or incapacitation of the first individual, the survivor's flowchart including a time reference identifying a time frame by which the stepwise instructions for coping with the death or incapacitation of the first individual should be commenced.

14. The method of claim 13 wherein the method is performed on a computer.

15. The method of claim 14 wherein at least a portion of the method is performed on the internet.

16. A system for assembling, retaining, and using information pertaining to an individual's life and estate in preparation for the individual's death or incapacitation, the system comprising:
an instruction including a first set of directions for assembling a source of information regarding a first individual's life and estate and a second set of directions for using the source of information by a second individual upon the death of the first individual; and,
a plurality of forms for recording and storing the source of information.

17. The system of claim 16 further comprising:
a means for binding the forms together once the forms have been completed by the first individual.

18. The system of claim 17 further comprising:
a plurality of dividers for separating the forms once fastened together by the means for binding.

19. The system of claim 18 wherein the instruction includes an assembler's flowchart including stepwise directions including a plurality of assembler's steps for creating the source of information.

20. The system of claim 16 wherein the instruction includes a survivor's flowchart including stepwise instructions including a plurality of survivor's steps for using the source of information.

21. The system of claim 20 wherein the survivor's flowchart further includes a time reference for instructing the survivor to perform each of the survivor steps within a predetermined timeframe.

22. The system of claim 16 wherein the plurality of forms includes at least one assembler's personal contact form for recording names and addresses of people known to the first individual and at least one assembler's personal property form for recording the identification of personal property owned by the first individual.

23. The system of claim 16 wherein the instruction includes a plurality of form letters.

24. The system of claim 20 wherein the plurality of survivor's steps include a plurality of survivor's forms.

25. The system of claim 24 wherein the survivor's forms selectively include a note written by the first individual.

26. The system of claim 16 wherein at least a portion of the system is embodied in computer software.

27. A method for developing a contingency plan in the event of the death or incapacitation of a person, the method comprising the steps of:
providing a medium for storing information;
collecting personal information regarding the person;
storing the personal information on the medium;
collecting financial information regarding the person; and
storing the financial information on the medium.
